(19) United States
(12) Patent Application Publication
(10) Pub. No.: US 2012/0317186 A1
(43) Pub. Date: Dec. 13, 2012

(54) WEB BASED SYSTEM AND METHOD FOR CROSS-SITE PERSONALISATION

(76) Inventors: Kevin Koidl, Dublin (IE); Brian Gallagher, Dublin (IE); Owen Conlan, Dublin (IE); Vincent Wade, Dublin (IE)

(21) Appl. No.: 13/495,260

(22) Filed: Jun. 13, 2012

Related U.S. Application Data
(60) Provisional application No. 61/496,305, filed on Jun. 13, 2011.

(51) Int. Cl. G06F 15/16

(52) U.S. Cl. 709/203

(57) ABSTRACT

A system and a method for configuring distributed network content in real time are disclosed. The system comprises a network, a plurality of user terminals and at least fist and second servers, all being connected to the network. The first server stores network content and distributes it according to network requests of remote user terminals. Each user terminal communicates data representative of user interaction with at least a portion of the network content to the second server, at which it is stored. The second server processes the stored data into respective network content-configuring data for each user terminal and the first server distributes next network content to each user terminal according to the respective network content-configuring data received from the at least second server.

This application claims the benefit of U.S. Provisional Patent Application 61/496,305 filed on 13 Jun. 2011, the specification of which is hereby incorporated herein by reference.

### BACKGROUND OF THE INVENTION

1. Field of the Invention

At least one embodiment of the invention relates to a distributed system and method for personalising network data across network data sources. In particular, at least one embodiment of the invention provides a system and method to enable a user to have a personalised experience when accessing data resources distributed across the world wide web.

2. Description of the Related Art

Currently personalisation on the world wide web (www) is mostly confined to websites of individual content providers, which record user preferences via tracking data structures known as cookies. When a user browses a same website associated with a cookie in the future, user preference data and/or activity to date on the website is retrieved by the website server, in order to show more relevant content. For example a web server may send a cookie containing the username last used to log in to a website so that it may be filled in for future visits. Users select preferences by inputting relevant data in a web form and submitting the form to the website server. The server encodes the preferences in a cookie and sends the cookie back to the browser on the user terminal. Thus, every time the user accesses a page, the server is also sent the cookie where the preferences are stored, and can personalize the page according to the user preferences.

A problem with this isolated approach is that the user is confronted with a fragmented browsing experience, as web servers do not share or cross link their respective cookies. In turn this leads to increased user frustration, since personalisation based on missing information about the user's previous browsing experience outside of the current website is distorted.

Most personalisation tools presently available are essentially rules engines with some performance improvements. Rules are created by expert analysts about what content should be distributed to users under which conditions. Expert analysts ideally understand both web dynamics and the context and/or purpose of the website and the organisation it portrays. The problem is that personalization rules are deficient, when used on their own, and the creation, maintenance and adaptation of rules is particularly labour-intensive and ever more expert-driven. Good rule sets are iterative and grow to be incredibly complex, paradoxically with an ever-shorter time span of relevance. As business and market changes for each user, the rules need constant adaptation and, eventually, outright replacement. Out-of-date rules can inhibit the conversion of users into perusing a website and the service(s) it provides. Rule sets, or “stacks” start growing from their very first inception, and never cease growing. The core shortcoming of this approach to content personalisation is that, as rules multiply, they begin to conflict with one another, the rule conflicts constituting a processing overhead of themselves. Accordingly, the benefits of rule-based personalization follow a generally counter-productive curve of ever-diminishing returns.

The well-known social website Facebook has recently disclosed and started distributing a service called ‘Instant Personalisation’, which uses user data, preferences and online behaviour stored by Facebook servers for interfacing with and personalising other websites, in order to try to normalise a user's website surfing experience. One example is the well-known movie rating website Rotten Tomatoes which, once a user allows it to access and use that user's Facebook profile, is personalised with movie ratings of the user's Facebook friends. The main difference in this approach is that the Facebook application is that it driven by social recommendations and interaction of a user, rather that a user's specific interest or task, thus the Facebook application is still not providing a cross-site personalisation of the surfing experience.

An improved method of configuring distributed network content is therefore required, and a system embodying this method, which mitigate at least the above shortcomings of the prior art.

### BRIEF SUMMARY OF THE INVENTION

At least one embodiment of the invention provides, as set out in the appended claims, a distributed method and system, wherein remote network content accessed by a user terminal across a network is personalised according to the user's interaction with the terminal, as an automatic background task independently of any active personalisation choices by the user. Typically, the distributed network content will be website data, and user interaction parameters, for instance type and content of websites accessed, site navigation instances, time spent before accessing further content and the like, are recorded and processed to pre-configure such further content after it is requested, but before it is received.

According to an embodiment of the invention, there is therefore provided a method of configuring distributed network content in real time, performed by a plurality of networked data processing terminals comprising a plurality of user terminals connected and at least fist and second servers, all connected to a network, the method comprising the steps of storing network content at the at least first server and distributing same therefrom according to network requests of remote user terminals; communicating, from each user terminal to the at least second server, data representative of user interaction with at least a portion of the network content; storing the data representative of user interaction at the at least second server; processing the stored data into respective network content-configuring data for each user terminal at the at least second server; and distributing next network content to each user terminal with the at least first server according to the respective network content-configuring data received from the at least second server.

In an embodiment of the method according to the invention, the method preferably comprises the further steps of obtaining an active script from the at least second server at each user terminal and capturing data representative of user interaction with the active script.

In an embodiment of the method according to the invention, the method preferably comprises the further step of storing, at the at least second server, the data representative of user interaction with at least a portion of the network content as a data record of a database comprising at least an event type, a network content source and a timestamp.

In an embodiment of the method according to the invention, the method preferably comprises the further step of storing the user terminal location, user terminal type and time of use in the data record.

In a variant of this embodiment, the step of processing the respective network content-configuring data may comprise the further step of correlating the data representative of user interaction with the stored location, terminal type and time of use.

In a variant of this embodiment, the method may comprise the further steps of pre-processing the network content of the at least first server, by obtaining the network data from the at least first server; extracting entities, terms and taxonomies data from the obtained network content; and storing the extracted data with the network content in a network content store.

In a variant of this embodiment, the method may comprise the further steps of determining relevance of data stored in the network content store according to the output of the correlation and to communicate data determined to be relevant to the at least first server as network content-configuring data.

According to another embodiment of the invention, there is also provided a system for personalised website browsing, comprising: means for interfacing a third-party service with individual websites; means for identifying other websites to a user of specific interest to that; and means for applying user centric and user controlled personalisation in a transparent manner to the user.

In an embodiment of this system according to the invention, the system is preferably adapted to generate the best content presentation for each interaction automatically based on intent clues.

In an embodiment of this system according to the invention, the system preferably provides an adaptive web personalisation to users across different and independent websites, by interfacing a third-party service with the individual sites.

In an embodiment of this system according to the invention, the system is preferably embodied across different devices such as electronic pads and smart phones with limited resources and displaying capacities.

According to yet another embodiment of the invention, there is also provided a system for configuring distributed network content in real time, comprising: a network; a plurality of user terminals connected to the network; and at least first and second servers connected to the network; wherein the at least first server is configured to store network content and to distribute same according to network requests of remote user terminals; wherein each user terminal is configured to communicate data representative of user interaction with at least a portion of the network content to the at least second server at which it is stored; wherein the at least second server is configured to process the stored data into respective network content-configuring data for each user terminal; and wherein the at least first server is further configured to distribute next network content to each user terminal according to the respective network content-configuring data received from the at least second server.

In an embodiment of this system according to the invention, each user terminal is preferably further configured with an active script for capturing data representative of user interaction thereat, and wherein the active script is obtained from the at least second server.

In an embodiment of this system according to the invention, the at least second server is preferably further configured to store the data representative of user interaction with at least a portion of the network content as a data record of a database comprising at least an event type, a network content source and a timestamp.

In an embodiment of this system according to the invention, the at least second server is preferably further configured to store the user terminal location, user terminal type and time of use in the data record.

In a variant of this embodiment, the at least second server may be further configured to correlate the data representative of user interaction with the stored location, terminal type and time of use when processing the respective network content-configuring data.

In a variant of this embodiment, the at least second server may be further configured to pre-process the network content of the at least first server, by obtaining the network data from the at least first server; extracting entities, terms and taxonomies data from the obtained network content; and storing the extracted data with the network content in a network content store.

In a variant of this embodiment, the at least second server may be further configured to determine relevance of data stored in the network content store according to the output of the correlation and to distribute data determined to be relevant to the at least first server as network content-configuring data.

For any of the method and system embodiments above, and further variants, the data representative of user interaction is any or all selected from the group comprising network address selections, network content navigation, alphanumerical data inputs, network content updating rate, human interface input.

For any of the method and system embodiments above, and further variants, the network content is any or all selected from the group comprising website content, audio data, image data, video data, audio-video sequences, interactive data.

For any of the method and system embodiments above, and further variants, each user terminal may be any selected from the group comprising mobile telephone handsets, desktop computers, portable computers, tablet computers, personal digital assistants, portable media players, home game consoles, portable game consoles, network-enabled television sets, network-enabled media playing devices.

According to still another embodiment of the invention, there is also provided a set of instructions recorded on a data carrying medium which, when processed by a data processing terminal connected to a network, configures the terminal to perform the steps of obtaining, from at least one remote user terminal, data representative of user interaction at the at least one remote user terminal with at least a portion of network content received from a first server; storing the data representative of user interaction; processing the stored data into respective network content-configuring data for the at least one remote user terminal; and communicating the distributing network content-configuring data to the first server.

The set of instructions may advantageously further configure the terminal to upload an active script to the at least one remote user terminal upon request, for capturing the data representative of user interaction thereat.

The set of instructions may be advantageously embodied as a JavaScript application or applet, an ActiveX applet or application, an application package file (‘APK’) for use with the Android™ operating system or an iPhone™ application archive (‘IPA’) for use with the iOS™ operating system.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 provides a functional diagram of the architecture of a system according to an embodiment of the invention.

FIG. 2 shows a network environment comprising a plurality of communication networks, mobile and static user terminals and at least first and second servers, embodying the system of FIG. 1.

FIG. 3 is a logical diagram of a typical hardware architecture of a mobile data communication device shown in FIG. 2, including memory means.

FIG. 4 is a logical diagram of a typical hardware architecture of a static user terminals and each server shown in FIG. 2, including memory means.

FIG. 5 details the data processing steps of an embodiment of the method according to an embodiment of the invention.

FIG. 6 is a logical diagram of the contents of the memory means of each mobile data communication device shown in FIGS. 2 and 3, when performing the method of FIG. 5, including a first set of instructions.

FIG. 7 is a logical diagram of the contents of the memory means of the second server shown in FIGS. 2 and 4, when performing the method of FIG. 5, including a second set of instructions and a database.

FIG. 8 provides an example of network content communicated from the first server to a user interface of a user communication device of FIGS. 2 and 3 according to the prior art.

FIG. 9 provides an example of network content communicated from the first server to a user interface of a user communication device of FIGS. 2 and 3 according to an embodiment of the invention.

### DETAILED DESCRIPTION OF THE INVENTION

There will now be described by way of example a specific mode contemplated by the inventors. In the following description numerous specific details are set forth in order to provide a thorough understanding. It will be apparent however, to one skilled in the art, that an embodiment of invention may be practiced without limitation to these specific details. In other instances, well known methods and structures have not been described in detail so as not to unnecessarily obscure the description.

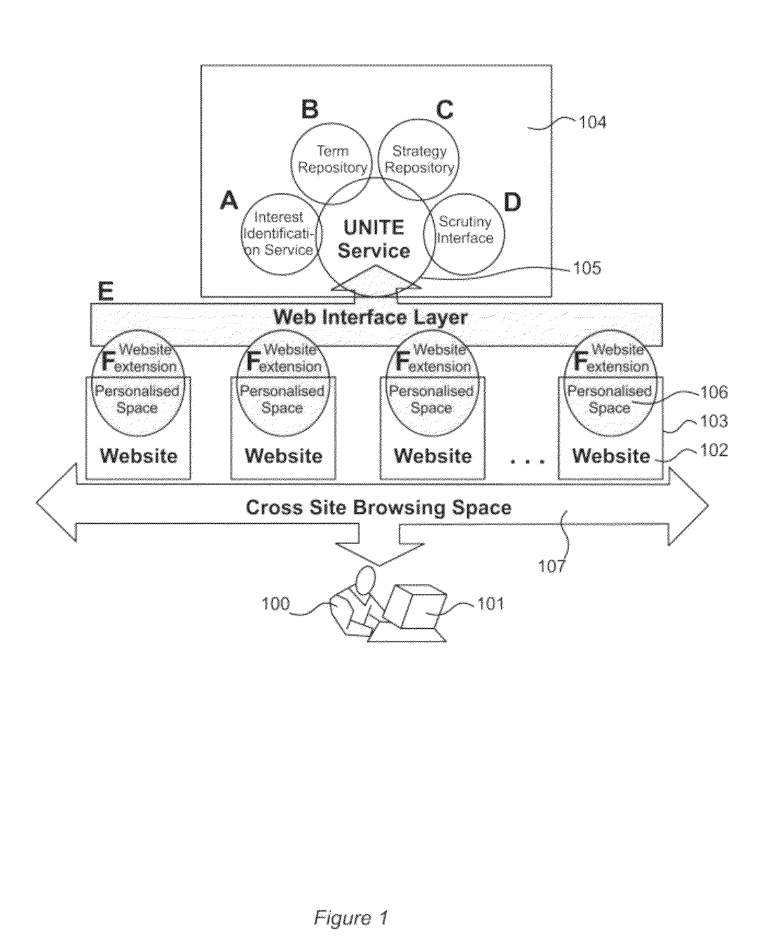

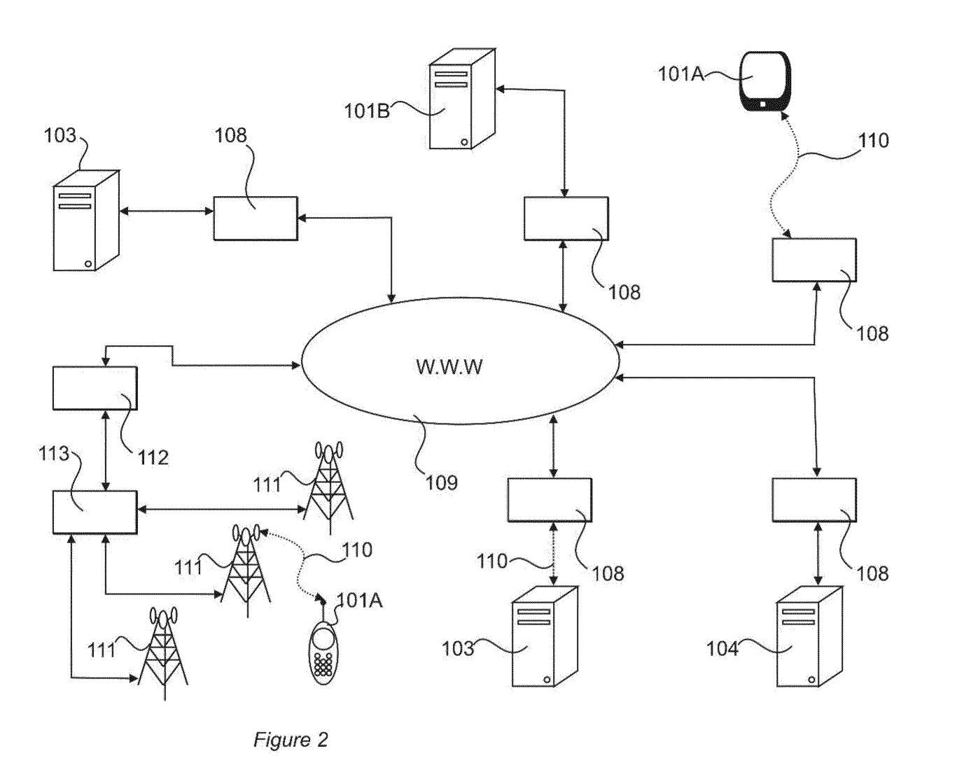

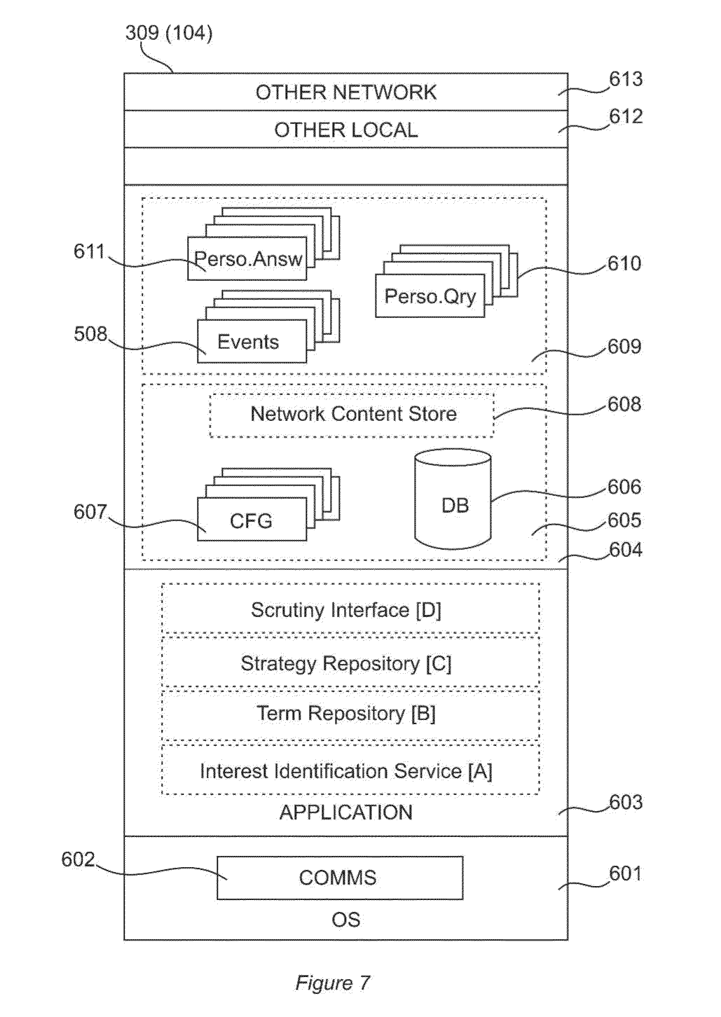

With reference to FIG. 1, a functional representation of a system architecture according to the invention is shown, in use by a user 100 with a static user terminal 101. The terminal 101 is connected to a Wide Area Network (WAN), typically the Internet or World Wide Web as will be described with reference to FIG. 2 hereafter, and accesses network content 102, typically website data, respectively from one or more remote first servers 103 likewise connected to the WAN. The terminal 101 communicates active and passive user interaction data in relation to accessed network content in real time to a second remote server 104 configured to provide a united personalisation service 105, for example in the form of a web based service, through a plurality of functional data processing modules A, B, C and D which will described with reference to FIG. 7 hereafter.

The remote server 104 configures each network content-distributing server 103 with a respective data interface F, typically embodied as an Application Programmer Interface (API), wherein the plurality of data interfaces F collectively define a web interface layer E between the server 104 and the website servers 103. The united personalisation service 105 processes the active and passive user interaction data communicated by the user terminal 101 for outputting network content-configuring data, which the data interface F at each website server 103 may receive through the web interface layer E.

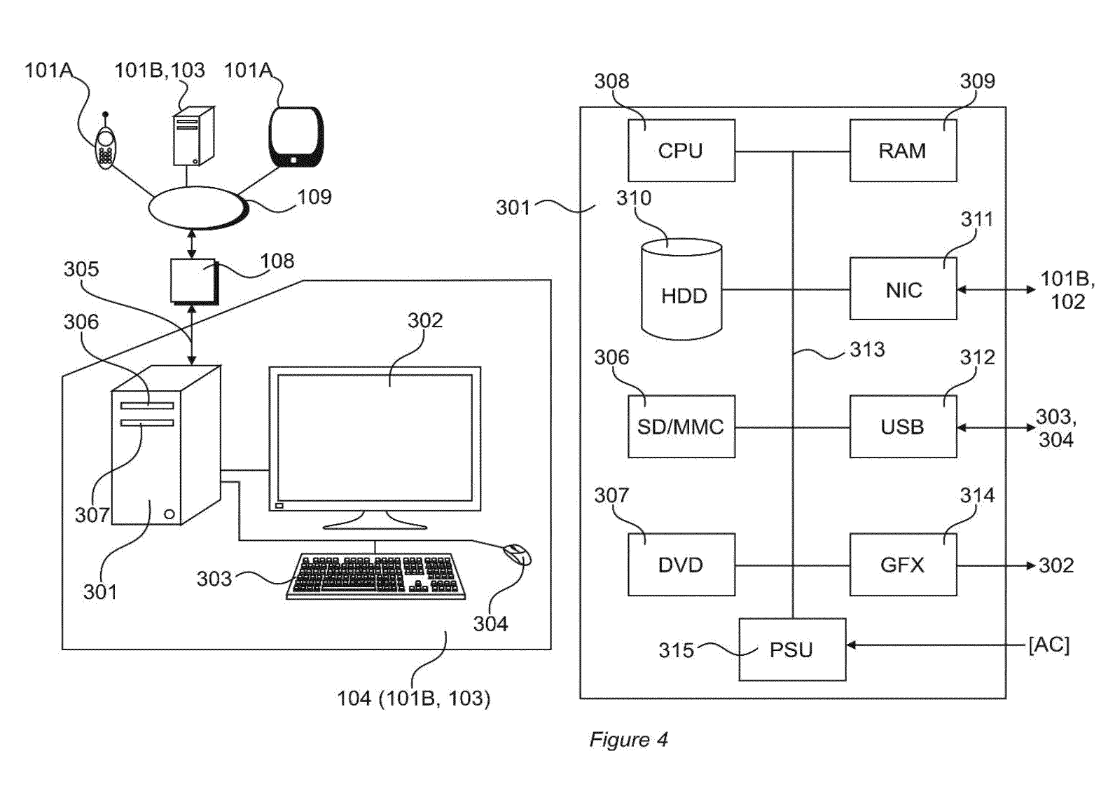

Upon receiving a next data request from the user terminal 101 over the WAN, any website server 103 processes its network content 102 with the received network content-configuring data into personalised network content 106, referred to as personalized space 106. The personalized spaces 106 across the plurality of website servers 103 collectively define a user interface layer 107, referred to as cross-site browsing space 107 and which, save as to an initial registration step which will described with reference to FIG. 4 hereafter, is entirely passive so far as the user experience and interaction at the terminal 101 is concerned.

With reference to FIG. 2, an example embodiment of the system of FIG. 1 according to the invention is shown within a networked environment, which includes a plurality of data processing terminals connected to a plurality of networks interfaced with one another. Mobile 101A and static 101B user terminals are operated by their respective users 100 to access network content stored at one or more first servers 103. A second server 104 receives active and passive user interaction data in relation to accessed network content in real time from each mobile and/or static user terminal 101A, 101B and communicates network content-configuring data to the at one or more first servers 102.

Each static user terminal 101 B and server 103, 104 emits and receives data encoded as a digital signal over a wired data transmission conforming to the IEEE 802.3 (‘Gigabit Ethernet’) standard, wherein the signal is relayed respectively to or from the computing device by a wired router 108 interfacing the computing device 101B, 102, 103 to the Wide Area Network (WAN) communication network 109. Generally, each data processing terminal 101B, 103, 104 may be any portable or desktop data processing device having at least networking means apt to establish a data communication with each other over the WAN 109, including any mobile data communication device 101A over the WAN 109 and further sub-networks as described hereafter.

The router 108 typically provides relevant connectivity to establish a wired Local Area Network (‘LAN’), one or more of the static user terminals 101B and servers 102, 103 may also have wireless telecommunication emitting and receiving functionality over and/or a wireless local area network (‘WLAN’) conforming to the 802.11 standard (‘Wi-Fi’). In the LAN or WLAN, telecommunication is likewise performed as voice, alphanumeric and/or audio-video data using the Internet Protocol (IP), Voice data over IP (‘VoIP’) protocol, Hypertext Transfer Protocol (‘HTTP’) or Secure Hypertext Transfer Protocol (‘HTTPS’), the signal being relayed respectively to or from the data communication device 101B, 103, 104 by the router 108.

In the example, any mobile data communication device 101A is a mobile telephone handset having wireless telecommunication emitting and receiving functionality over a cellular telephone network configured according to the Global System for Mobile Communication (‘GSM’), General Packet Radio Service (‘GPRS’), International Mobile Telecommunications-2000 (IMT-2000, ‘W-CDMA’ or ‘3G’) network industry standards, and wherein telecommunication is performed as voice, alphanumeric or audio-video data using the Short Message Service (‘SMS’) protocol, the Wireless Application protocol (‘WAP’) the Hypertext Transfer Protocol (‘HTTP’) or the Secure Hypertext Transfer Protocol (‘HTTPS’).

A mobile telephone handset 101A receives or emits voice, text, audio and/or image data encoded as a digital signal over a wireless data transmission 110, wherein the signal is relayed respectively to or from the handset by the geographically-closest communication link relay 111 of a plurality thereof. The plurality of communication link relays 111 allows digital signals to be routed between each handset 101A and their destination 103, 104 across the WAN network 109 by means of a remote gateway 112 via a MSC or base station 113. Gateway 112 is for instance a communication network switch, which couples digital signal traffic between wireless telecommunication networks, such as the cellular network within which wireless data transmissions 110 take place, and the WAN 109. The gateway 112 further provides protocol conversion if required, for instance whether a handset 101A uses the WAP or HTTPS protocol to communicate data. A mobile telephone handset 101A may also have wireless telecommunication emitting and receiving functionality over the WLAN provided by a router 108 in addition to GSM, GPRS, W-CDMA and/or 3G.

A typical handset 101A for use with the system according to the invention is preferably that commonly referred to as a ‘smartphone’ and may for instance be an iPhone™ handset manufactured by the Apple Corporation or a Nexus One™ handset manufactured for Google, Inc. by the HTC Corporation. Generally, the mobile terminal 101A may be any portable data processing device having at least wireless communication means and audio recording and storage means. It will therefore be readily understood by the skilled person from the present disclosure, that one or more of the mobile data communication devices 101A may instead be a portable computer commonly referred to as a ‘laptop’ or ‘netbook’, a tablet computer such as an Apple™ iPad™ or a Motorola™ XOOM™, a personal digital assistant such as an Hewlett-Packard™ iPaq™, a portable media player such as an Archos™ 43 Android™ PMP, or even a portable game console such as a Sony™ Playstation™ Vita™.

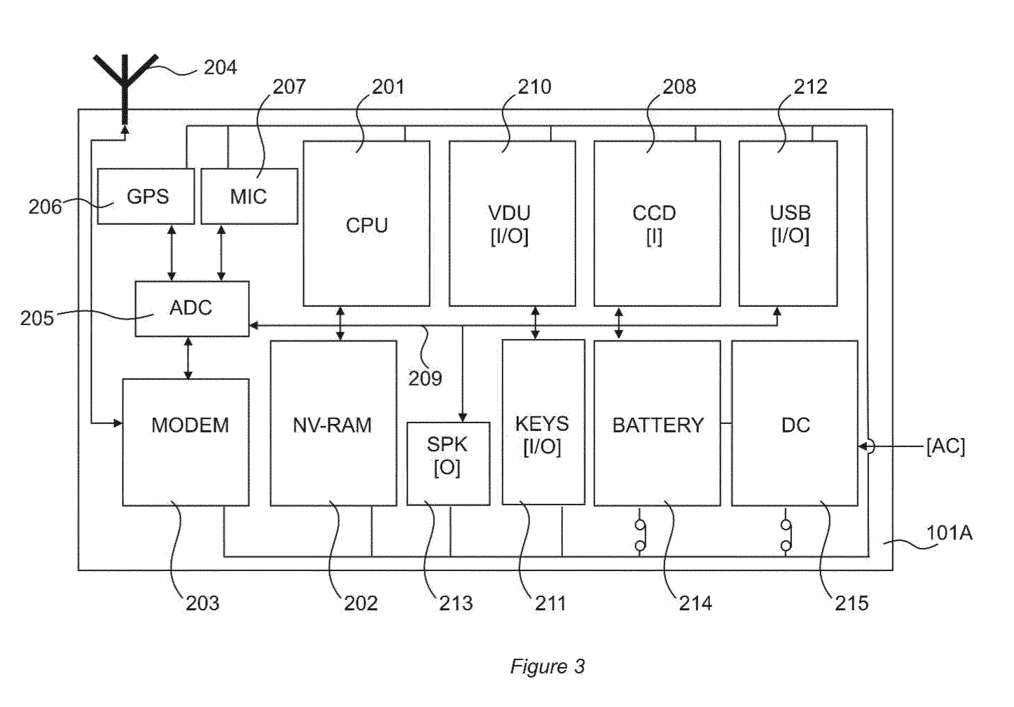

A typical hardware architecture of a mobile telephone handset 101A is shown in FIG. 3 in further detail, by way of non-limitative example. The handset 101A firstly includes a data processing unit 201, for instance a general-purpose microprocessor (CPU), acting as the main controller of the handset 101A and which is coupled with memory means 202, comprising non-volatile random-access memory (‘NVRAM’).

The mobile telephone handset 101A further includes a modem 203 to implement the wireless communication functionality, as the modem provides the hardware interface to external communication systems, such as the GSM or GPRS cellular telephone network 111, 112, 113 shown in FIG. 2. An aerial 204 coupled with the modem 203 facilitates the reception of wireless signals from nearby communication link relays 106 and, for some handsets 101A, from nearby FM signal emitters 101C, 102C. The modem 203 is interfaced with or includes an analogue-to-digital converter 205 (‘ADC’) for demodulating wavelength wireless signals, for instance the first audio data 101A, 102A received via the antenna 204 into digital data, and reciprocally for outgoing data.

The handset 101A further includes self-locating means in the form of a GPS receiver 206, wherein the ADC 205 receives analogue positional and time data from orbiting satellites (not shown), which the data processing unit 201 or a dedicated data processing unit processes into digital positional and time data.

The handset 101A further includes a sound transducer 207, for converting ambient sound waves, such as the user's voice and first audio data 101A, 102A, into an analogue signal, which the ADC 205 receives for the data processing unit 201 or a dedicated data processing unit to process into digital first audio data.

The handset 101A may optionally further include imaging means 208 in the form of an electronic image sensor, for capturing image data which the data processing unit 201 or a dedicated data processing unit processes into digital image data.

The CPU 201, NVRAM 202, modem 203, GPS receiver 206, microphone 207 and optional digital camera 208 are connected by a data input/output bus 209, over which they communicate and to which further components of the handset 101A are similarly connected, in order to provide wireless communication functionality and receive user interrupts, inputs and configuration data.

Alphanumerical and/or image data processed by CPU 201 is output to a video display unit 210 (‘VDU’), from which user interrupts may also be received if it is a touch screen display. Further user interrupts may also be received from a keypad 211 of the handset, or from an external human interface device (‘HiD’) connected to the handset via a Universal Serial Bus (‘USB’) interface 212. The USB interface advantageously also allows the CPU 201 to read data from and/or write data to an external or removable storage device. Audio data processed by CPU 201 is output to a speaker unit 213.

Power is provided to the handset 101A by an internal module battery 214, which an electrical converter 215 charges from a mains power supply as and when required.

A typical hardware architecture of each static user terminal 101B and server 103, 104 is now shown in FIG. 4 in further detail, by way of non-limitative example. The data processing device 110 is a computer configured with a data processing unit 301, data outputting means such as video display unit (VDU) 302, data inputting means such as HiD devices, commonly a keyboard 303 and a pointing device (mouse) 304, as well as the VDU 302 itself if it is a touch screen display, and data inputting/outputting means such as the wired network connection 305 to the communication network 104 via the router 109, a magnetic data-carrying medium reader/writer 306 and an optical data-carrying medium reader/writer 307.

Within data processing unit 301, a central processing unit (CPU) 308 provides task co-ordination and data processing functionality. Sets of instructions and data for the CPU 308 are stored in memory means 309 and a hard disk storage unit 310 facilitates non-volatile storage of the instructions and the data. A wireless network interface card (NIC) 311 provides the interface to the network connection 305. A universal serial bus (USB) input/output interface 312 facilitates connection to the keyboard and pointing devices 303, 304.

All of the above components are connected to a data input/output bus 313, to which the magnetic data-carrying medium reader/writer 306 and optical data-carrying medium reader/writer 307 are also connected. A video adapter 314 receives CPU instructions over the bus 313 for outputting processed data to VDU 302. All the components of data processing unit 301 are powered by a power supply unit 315, which receives electrical power from a local mains power source and transforms same according to component ratings and requirements.

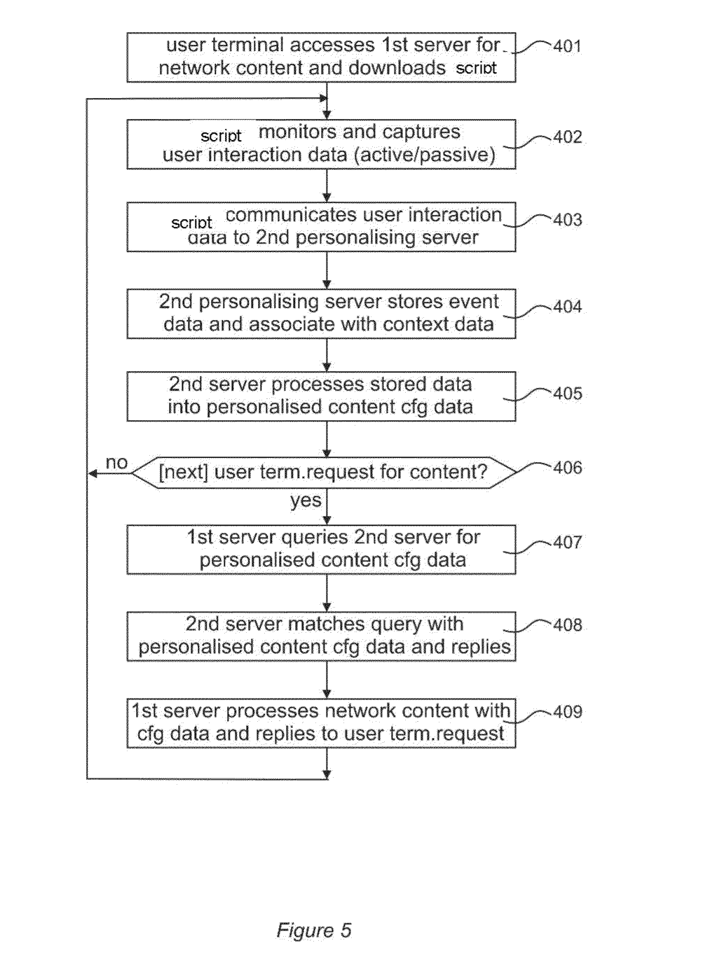

FIG. 5 details data processing steps of an embodiment of a method, performed in the environment of FIG. 2 with a user terminal 101A or 101B, at least one first server 103 and the second server 104 according to the architecture described in relation to FIG. 1.

At step 401, the mobile or static user terminal 101A, 101B first accesses at least one first server 103 for network content, for instance a first website page, with a first network request, and obtains an active script from the second server 104, which is associated with the first server 103. Step 401 is performed once, when the mobile or static user terminal 101A, 101B requests network content from the first server 103 for the first time ever. Accordingly, accessing a further first server 103, for instance for alternative network content, for the first time again triggers step 401. Obtaining the active script may be subjected to the user's approval.

At step 402, the active script monitors and captures user interaction at the mobile or static user terminal 101A, 101B with some or all of the network content obtained from the first server 103, as event data. At step 403, the active script communicates the event data to the second server 104. The active script is a self-contained subroutine which is processed substantially in parallel with any other data processing task performed by the mobile or static user terminal 101A, 101B, for instance the network content-accessing and -displaying application used for performing step 401. Accordingly, the active script is permanently monitoring, capturing and communicating user interaction in real-time at steps 402 and 403.

At step 404, the second server 104 stores the received event data in a database, and associates with it an event type, a timestamp and the network content source, for instance the respective network addresses of the first server 103 and the network content thereof accessed at step 401.

At step 405, the second server 104 processes the stored event data into network content-configuring data for the user terminal 101A, 101B. The second server 104 generates a transient user interest representation from the received event date, for instance by correlating the event data with other indicators, such as the user terminal location provided to the active script by the GPS 206 of user terminal 101A, the user terminal type provided to the active script by the terminal operating system, and the time of use. The second server 104 then produces personalised content recommendations in real-time from the transient user interest representation, for instance by determining relevance of data stored in the network content of steps 401 to 404 according to the output of the correlation.

At step 406, a question is asked as to whether the mobile or static user terminal 101A, 101B has sent a second network request to the first server 103 for next network content, for instance a second website page. If the question is answered negatively, control returns to step 402 at which the active script on the user terminal is still monitoring, capturing and reporting event data to the second server 104. Alternatively, the question of step 406 is answered positively whereby, at step 407, the first server 103 is prompted by the second network request to query the second server 104 for personalised content recommendations for the requesting user terminal 101A, 101B.

At step 408, the second server 104 communicates the current personalised content recommendations of step 405 to the first server 103. At step 409, the first server 103 processes its stored content data according to the personalised content recommendations, and distributes the output personalised content data 106 to the requesting user terminal 101A, 101B in reply to the second network request. Control returns to step 402 at which the active script on the user terminal is still monitoring, capturing and reporting event data to the second server 104, now in respect of the personalised content data 106.

In an alternative embodiment, the second server 104 may further access the network content and store and associate same with the event data at step 404 and, at step 405, pre-process the network content by obtaining the network data 102 from the at least first server 103, extracting entities, terms and taxonomies data from the obtained network content 102, and storing the extracted data with the network content in a network content store of the, or associated with, the database of step 404. Thereafter, at step 405, relevance of data stored in the network content store may be determined according to the output of the correlation and, at step 408, data determined to be relevant may be communicate to the first server 103 as the network content-configuring data.

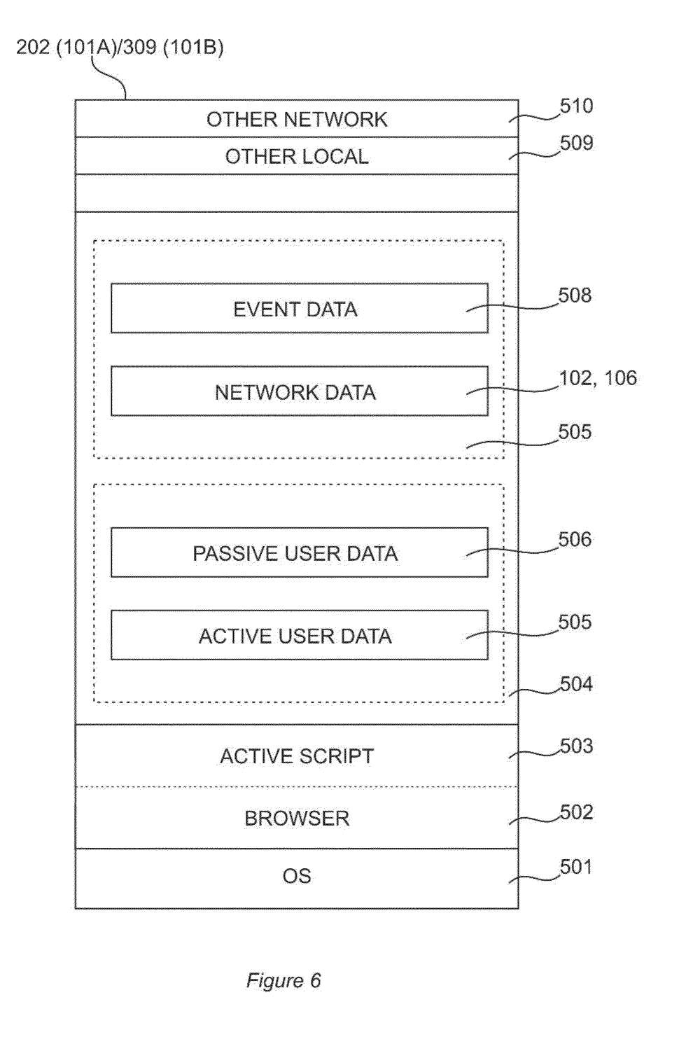

FIG. 6 is a logical diagram of the contents of the memory means 202 or 309 of, respectively, a mobile user terminal 101A or a static user terminal 101B, when performing steps 401, 402 and 406 at runtime. An operating system is shown at 501 which, if the terminal is mobile 101A, and depending on the handset manufacturer, may be iOS 5™ developed and distributed by Apple Inc. or Android™ developed and distributed by Google Inc. or, alternatively, if the terminal is static 101B, is for instance Windows 7™ distributed by the Microsoft Corporation.

A browser application is shown at 502, which configures the user terminal 101A, 101B to remotely access servers 103, 104, to obtain network data 102, 106 and to display it locally. The active script, for instance a JavaScript applet or application, obtained at step 401 is shown at 503, which configures the user terminal 101A, 101B to perform the capturing and communicating of steps 402, 403. The active script 503 and the application 502 are interfaced with the OS 501 via one or more suitable Application Programmer Interfaces (‘API’) implementing functional interoperability, in order to access the networking functionality thereof as required.

Application data is shown at 504, which comprises local and network data. Local data comprises active user input data 505, typically generated by human interface devices (HiD) such as touch screen display 210 and/or keypad 211 and/or keyboard 303 and/or mouse 304. Active user input data 505 corresponds to local user interaction with the browser application 502, for instance navigation choices, data and/or network address selections, alphanumerical value inputting and the like, some or all of which is captured by the active script 503 at step 402.

Local data further comprises passive user input data 506 captured by the active script 503. Passive user input data 506 corresponds to user behavioural data extrapolated from non-functional user input and/or the absence of any user input. Such data may for instance include periods of time elapsed between each active user interaction with the browser application, periods of time elapsed between specific types of active user interaction with the browser application, on-screen cursor positional data over time and the like. Network data 507 comprises network data 102, 106 obtained from the first server 102 for processing by the browser 502, and the event data 508 of step 403 buffered for communication to the second server 104.

The memory 202 may further comprise local and/or network data that is unrelated to application 502 and active script 503, respectively shown at 509 and 510, for instance used by or generated for another application being processed in parallel with application 502 and the active script 503 associated therewith.

FIG. 7 is a logical diagram of the contents of the memory means 309 of the second server 104, when performing steps 404 to 409 at runtime. An operating system is shown at 601, which is for instance Windows 7™ distributed by the Microsoft Corporation. The OS 601 includes communication subroutines 602 to configure the server for bilateral network communication via the NIC 311.

An application is shown at 603, which configures the server 104 to perform at least processing steps 404 to 409 as described hereinbefore, and which is interfaced with the OS 601 and network communication subroutines 602 thereof via one or more suitable Application Programmer Interfaces (API) implementing functional interoperability, in order to access the networking functionality thereof as required. The application comprises four data processing modules, respectively an Interest Identification Service module A, a Term Repository B, a Strategy Repository C and a Scrutiny Interface D.

Application data is shown at 604, which comprises local and network data. Local data 605 comprises the database 606 of step 404, and respective network content-configuring data 607 of step 405 for each user terminal 101A, 101B in use having a respective, instantiated active script 503, thus including transient user interest representations, correlation outputs and personalised content recommendations. In an alternative embodiment, local data may further comprise a network content store 608.

Network data 609 comprises event data 508 received from each active script 503 instantiated at a respective mobile or static user terminal 101A, 101B for updating the database 605 therewith, network content personalisation queries 610 received from respective active scripts of first servers 103 according to step 407, and personalised content recommendations data 611 of step 408 buffered for communication to first servers 103.

The memory 309 may further comprise local and/or network data that is unrelated to application 603, respectively shown at 612 and 613, for instance used by or generated for another application being processed in parallel with application 603.

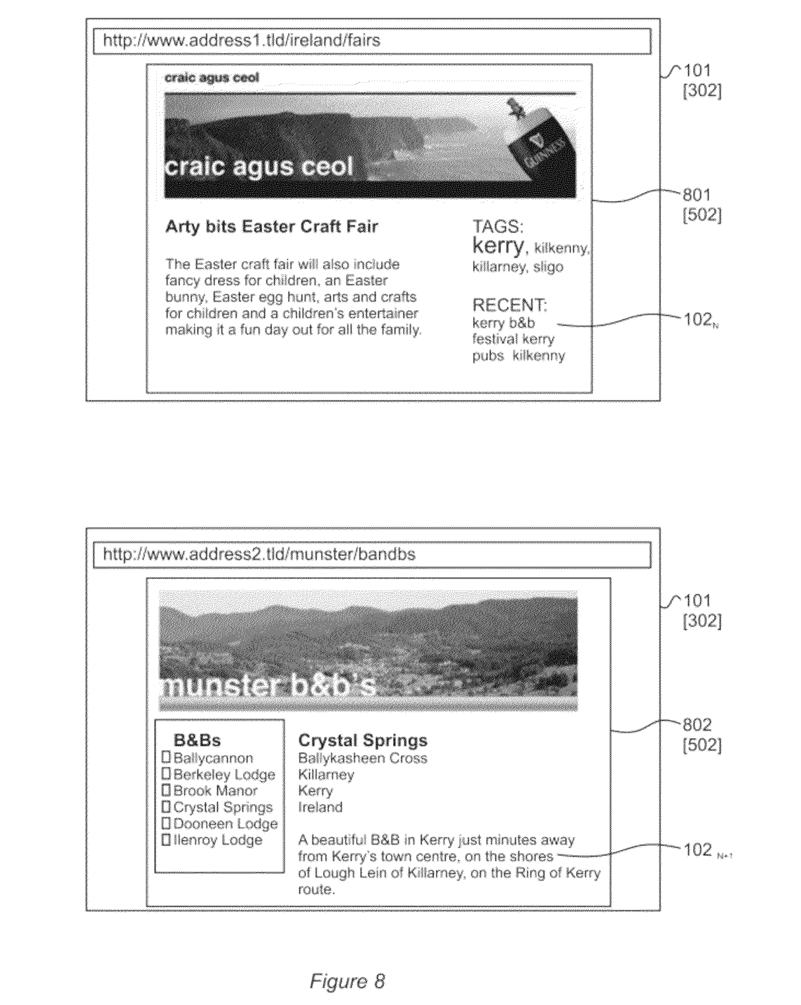

FIG. 8 illustrates an example of a prior art interaction between a user 100 at a conventional user terminal 101 with network content of a conventional server 103, with two successive displays 801, 802 of, respectively, first and second network content 102, 102 shown in the user interface of a browser application 502.

The user 100 causes the terminal 101 to access and obtain first network content 102 from the first server 103, shown in display 801. The user 100 peruses the information displayed, which relates to temporary accommodation providers in the area of Kerry, Ireland. The user may hover or highlight portions of text content with the mouse 304 for facilitating reading, may cause the displayed website page 801 to scroll up or down, may modify information or relevance ranking locally, and still cause more interactions without the need to query the first server 103 for second network content.

Having perused the first network content 102 as exhaustively as required, the user 100 eventually causes the terminal 101 to access and obtain second network content 102 from the first server 103, shown in display 802. The user 100 peruses the information displayed, which now relates to a specific temporary accommodation provider in the area of Kerry, Ireland, selected in the first content. The second network content 102 received is substantially conventional, as stored at the first server 103 in a default format, and not personalized according to the user's interest in the Kerry area.

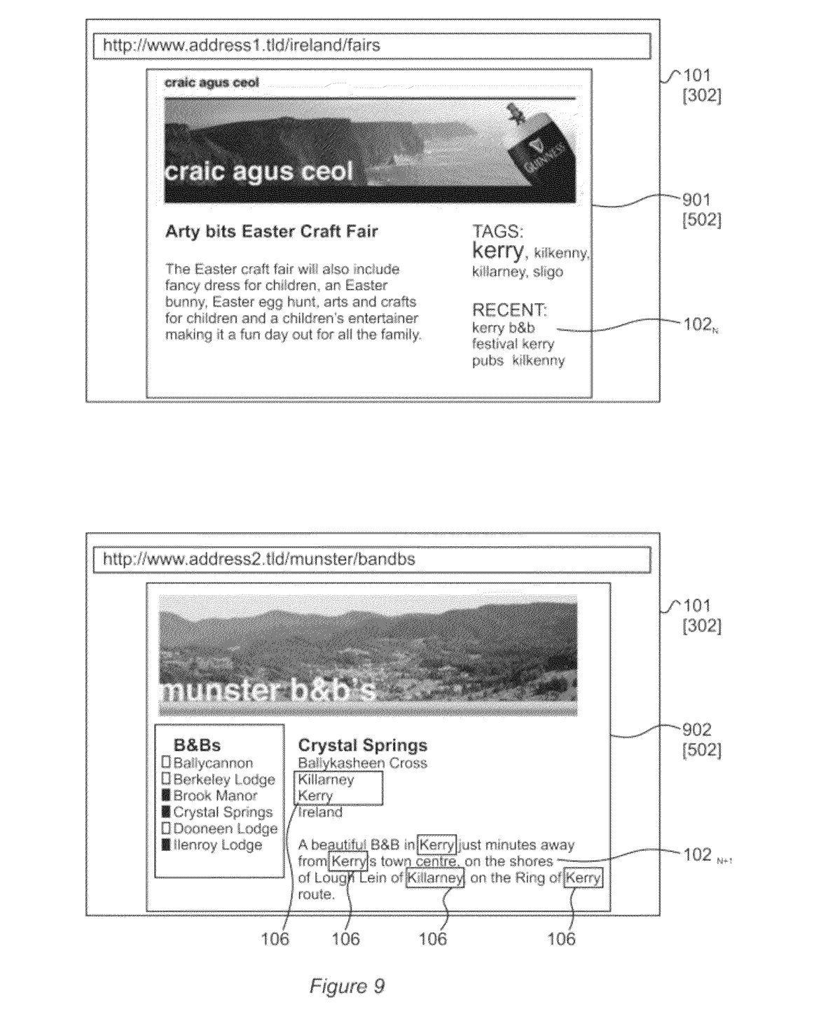

By contrast with FIG. 8, FIG. 9 illustrates an example of interaction between a user 100 at a user terminal 101 with network content of a server 103 as personalized through the second server 104, with two successive displays 901, 902 of, respectively, first and second network content 102, 106 shown in the user interface of a browser application 502.

The user 100 again causes the terminal 101 to access and obtain first network content 102 from the first server 102, shown in display 901. Pursuant to step 401, the active script 503 is also loaded from the second server 104 at that time, and monitors and captures user interaction at step 402, thus any hovering or highlighting of text portions of content with the mouse 304, scrolling of the displayed website page 903, modification of information or relevance ranking. Corresponding event data 508 is communicated to the second server 104 in real-time.

The user 100 again eventually selects a specific temporary accommodation provider in the area of Kerry, Ireland, in the first content 102, translated as a network query for second network content 102 to the first server 103. Pursuant to steps 406 and 407, the first server 103 queries the second server 104 for personalised content recommendations for the requesting user terminal 101. The second server 104, having determined from the event data 508 that the user is currently interested in Kerry, communicates corresponding personalised content recommendations to the first server 103.

Pursuant to step 409, the first server 103 processes its stored content data according to the ‘Kerry’ personalised content recommendation, and distributes the output personalised content data 106 to the requesting user terminal 101 in reply to the second network request, shown in display 902. The user 100 peruses the information displayed, which is substantially the same information as shown at 802, however now personalized with highlighting in color of the term ‘Kerry’ throughout, in order to further facilitate the user's perusal of the second network content.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal, which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A method of configuring distributed network content in real time, performed by a plurality of networked data processing terminals comprising a plurality of user terminals connected and at least first and second servers, all connected to a network, the method comprising the steps of
storing network content at the at least first server and distributing same therefrom according to network requests of remote user terminals;
communicating, from each user terminal to the at least second server, data representative of user interaction with at least a portion of the network content;
storing the data representative of user interaction at the at least second server;
processing the stored data into respective network content and configuring data for each user terminal at the at least second server; and
distributing next network content to each user terminal with the at least first server according to the respective network content and configuring data received from the at least second server.

2. A method according to claim 1, wherein the data representative of user interaction is any or all selected from the group comprising network address selections, network content navigation, alphanumerical data inputs, network content updating rate, human interface input.

3. A method according to claim 1, wherein the network content is any or all selected from the group comprising website content, audio data, image data, video data, audio-video sequences, interactive data.

4. A method according to claim 1, comprising the further steps of obtaining an active script from the at least second server at each user terminal and capturing data representative of user interaction with the active script.

5. A method according to claim 1, comprising the further step of storing, at the at least second server, the data representative of user interaction with at least a portion of the network content as a data record of a database comprising at least an event type, a network content source and a timestamp.

6. A method according to claim 5, comprising the further step of storing the user terminal location, user terminal type and time of use in the data record; and/or wherein the step of processing the respective network content and configuring data comprises the further step of correlating the data representative of user interaction with the stored location, terminal type and time of use; and/or comprising the further steps of pre-processing the network content of the at least first server, by obtaining the network data from the at least first server; extracting entities, terms and taxonomies data from the obtained network content; and storing the extracted data with the network content in a network content store; and/or comprising the further steps of determining relevance of data stored in the network content store according to the output of the correlation and to communicate data determined to be relevant to the at least first server as network content and configuring data.

7. A method according to claim 1, wherein any in the plurality of mobile data communication devices is selected from the group comprising mobile telephone handsets, tablet computers, portable computers, personal digital assistants, portable media players, portable game consoles.

8. A system for personalised website browsing, comprising:
means for interfacing a third-party service with individual websites;
means for identifying other websites to a user of specific interest to that; and
means for applying user centric and user controlled personalisation in a transparent manner to the user.

9. A system according to claim 8, adapted to generate the best content presentation for each interaction automatically based on intent clues.

10. A system according to claim 8, providing an adaptive web personalisation to users across different and independent websites, by interfacing a third-party service with the individual sites.

11. A system according to claim 8, embodied across different devices such as electronic pads and smart phones with limited resources and displaying capacities.

12. A system for configuring distributed network content in real time, comprising:
a network;
a plurality of user terminals connected to the network; and
at least first and second servers connected to the network;
wherein the at least first server is configured to store network content and to distribute same according to network requests of remote user terminals;
wherein each user terminal is configured to communicate data representative of user interaction with at least a portion of the network content to the at least second server at which it is stored;
wherein the at least second server is configured to process the stored data into respective network content and configuring data for each user terminal; and
wherein the at least first server is further configured to distribute next network content to each user terminal according to the respective network content and configuring data received from the at least second server.

13. A system according to claim 12, wherein the data representative of user interaction is any or all selected from the group comprising network address selections, network content navigation, alphanumerical data inputs, network content updating rate.

14. A system according to claim 12, wherein the network content is any or all selected from the group comprising website content, audio data, image data, video data, audio-video sequences, interactive data.

15. A system according to claim 12, wherein each user terminal is any selected from the group comprising mobile telephone handsets, desktop computers, portable computers, tablet computers, personal digital assistants, portable media players, home game consoles, portable game consoles, network-enabled television sets, network-enabled media playing devices.

16. A system according to claim 12, wherein each user terminal is further configured with an active script for capturing data representative of user interaction thereat, and wherein the active script is obtained from the at least second server.

17. A system according to claim 12, wherein the at least second server is configured to store the data representative of user interaction with at least a portion of the network content as a data record of a database comprising at least an event type, a network content source and a timestamp.

18. A system according to claim 17, wherein the at least second server is further configured to store the user terminal location, user terminal type and time of use in the data record; and/or wherein the at least second server is further configured to correlate the data representative of user interaction with the stored location, terminal type and time of use when processing the respective network content and configuring data; and/or wherein the at least second server is further configured to pre-process the network content of the at least first server, by obtaining the network data from the at least first server; extracting entities, terms and taxonomies data from the obtained network content; and storing the extracted data with the network content in a network content store and/or wherein the at least second server is further configured to determine relevance of data stored in the network content store according to the output of the correlation and to distribute data determined to be relevant to the at least first server as network content and configuring data.

19. A data carrying medium comprising a set of instructions which, when processed by a data processing terminal connected to a network, configures the terminal to perform the steps of
obtaining, from at least one remote user terminal, data representative of user interaction at the at least one remote user terminal with at least a portion of network content received from a first server;
storing the data representative of user interaction;
processing the stored data into respective network content and configuring data for the at least one remote user terminal; and
communicating the distributing network content and configuring data to the first server.
